(19) United States
(12) Patent Application Publication
(10) Pub. No.: US 2014/0307610 A1
(43) Pub. Date: Oct. 16, 2014

(54) MULTIMEDIA BROADCAST MULTICAST SERVICES OVER DISTRIBUTED ANTENNA SYSTEM

(71) Applicant: Alcatel-Lucent USA Inc., Murray Hill, NJ (US)

(72) Inventors: Ashok N. RUDRAPATNA, Basking Ridge, NJ (US); Arupjyoti BHUYAN, Naperville, IL (US); Tomas S. YOUNG, Parisppany, NJ (US)

(73) Assignee: Alcatel-Lucent USA Inc., Murray Hill, NJ (US)

(21) Appl. No.: 13/861,508

(22) Filed: Apr. 12, 2013

(51) Int. Cl. H04W 72/00; H04L 29/08

(52) U.S. Cl. CPC H04W 72/005; H04L 67/1095
USPC 370/312

(57) ABSTRACT

In a method for broadcasting multimedia broadcast multicast services (MBMS) signals over a distributed antenna system, a MBMS signal is broadcast from a plurality of distributed antenna system radio frequency nodes of the distributed antenna system within a sector of a wireless network. The MBMS signal broadcast from each of the plurality of distributed antenna system radio frequency nodes being the same.

### BACKGROUND

Multimedia broadcast multicast services (MBMS) are point-to-multipoint interface specifications for wireless technologies such as 3rd Generation Partnership Project Long-Term Evolution (3GPP LTE), wideband code divisional multiple access (WCDMA), universal mobile telecommunication system (UMTS), enhanced voice-data optimized (EVDO)/high rate packet data (HRPD), digital video broadcast (DVB), DVB-Terrestrial (DVB-T), DVB-Satellite (DVB-S), DVB-Satellite Services to Handhelds (DVB-SH), etc. For 3GPP LTE networks, the service is referred to as enhanced MBMS (eMBMS).

In these conventional systems, identical broadcast signals are transmitted from multiple base stations to user equipments in a synchronized manner to achieve what is referred to as a single frequency network (SFN). For eMBMS this is referred to as a multicast broadcast SFN (MBSFN). Such a transmission scheme yields power combining over the air resulting in improved signal-to-noise-plus-interference-ratio (SINR).

FIG. 1 illustrates a portion of a conventional multimedia broadcast multicast service (MBMS) architecture.

Referring to FIG. 1, the MBMS architecture includes a broadcast content source 100 that provides multimedia broadcast content (e.g., video, audio, etc.) to a plurality of base stations 110. The plurality of base stations 110 convert the multimedia broadcast content into MBMS radio-frequency (RF) signals and broadcast the MBMS signals to end users in the serving sectors or areas.

The performance of a scheme such as that shown in FIG. 1 depends on tight synchronization across the base stations participating in the SFN operation. The required synchronization is at multiple levels, including the physical layer and the applications layer, and must be achieved at the transmit antennas across the base stations. The synchronization may be achieved at the modem level across base stations, but achieving synchronization at the transmit antennas across base stations is relatively difficult since internal base station latencies are relatively difficult to control and compensate.

### SUMMARY

At least one example embodiment provides a method for broadcasting multimedia broadcast multicast services (MBMS) signals over a distributed antenna system. According to at least this example embodiment, the method includes: broadcasting a MBMS signal from a plurality of distributed antenna system radio frequency nodes of the distributed antenna system within a sector of a wireless network, the MBMS signal broadcast from each of the plurality of distributed antenna system radio frequency nodes being the same.

According to at least some example embodiments, the method may further include: replicating the MBMS signal; and applying the same MBMS signal to each of the plurality of distributed antenna system radio frequency nodes. The MBMS signal may be generated based on multimedia content received from a broadcast content source. Each of the plurality of distributed antenna system radio frequency nodes may receive the MBMS signal from a same single base station in the sector.

At least one other example embodiment provides a method for receiving multimedia broadcast multicast services (MBMS) signals over a distributed antenna system. According to at least this example embodiment, the method includes: receiving, at a radio-frequency equipment, a broadcast MBMS signal from a plurality of distributed antenna system radio frequency nodes of the distributed antenna system within a sector of a wireless network. The broadcast MBMS signal received from each of the distributed antenna system radio frequency nodes is the same.

According to at least some example embodiments, the broadcast MBMS signal may be from a single base station in the sector.

At least one other example embodiment provides a system for broadcasting multimedia broadcast multicast services (MBMS) signals. According to at least this example embodiment, the system includes: a radio frequency equipment to generate a MBMS signal based on multimedia content from a broadcast content source; and a distributed antenna system having a plurality of distributed antenna system radio frequency nodes configured to broadcast the MBMS signal within a sector of a wireless network. The MBMS signal broadcast from each of the plurality of distributed antenna system radio frequency nodes is the same.

According to at least some example embodiments, the distributed antenna system may include a distributed antenna system head end unit configured to replicate the MBMS signal, and to apply the same MBMS signal to each of the plurality of distributed antenna system radio frequency nodes.

### BRIEF DESCRIPTION OF THE DRAWINGS

The present invention will become more fully understood from the detailed description given herein below and the accompanying drawings, wherein like elements are represented by like reference numerals, which are given by way of illustration only and thus are not limiting of the present invention.

FIG. 1 illustrates a portion of a conventional multimedia broadcast multicast service (MBMS) architecture;

FIG. 2 illustrates a portion of a MBMS architecture according to an example embodiment.

It should be noted that these Figures are intended to illustrate the general characteristics of methods, structure and/or materials utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments. The use of similar or identical reference numbers in the various drawings is intended to indicate the presence of a similar or identical element or feature.

### DETAILED DESCRIPTION OF THE EMBODIMENTS

Various example embodiments will now be described more fully with reference to the accompanying drawings in which some example embodiments are shown.

Detailed illustrative embodiments are disclosed herein. However, specific structural and functional details disclosed herein are merely representative for purposes of describing example embodiments. This invention may, however, be embodied in many alternate forms and should not be construed as limited to only the embodiments set forth herein.

Accordingly, while example embodiments are capable of various modifications and alternative forms, the embodiments are shown by way of example in the drawings and will be described herein in detail. It should be understood, however, that there is no intent to limit example embodiments to the particular forms disclosed. On the contrary, example embodiments are to cover all modifications, equivalents, and alternatives falling within the scope of this disclosure. Like numbers refer to like elements throughout the description of the figures.

Although the terms first, second, etc. may be used herein to describe various elements, these elements should not be limited by these terms. These terms are only used to distinguish one element from another. For example, a first element could be termed a second element, and similarly, a second element could be termed a first element, without departing from the scope of this disclosure. As used herein, the term “and/or,” includes any and all combinations of one or more of the associated listed items.

When an element is referred to as being “connected,” or “coupled,” to another element, it can be directly connected or coupled to the other element or intervening elements may be present. By contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting. As used herein, the singular forms “a,” “an,” and “the,” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Specific details are provided in the following description to provide a thorough understanding of example embodiments. However, it will be understood by one of ordinary skill in the art that example embodiments may be practiced without these specific details. For example, systems may be shown in block diagrams so as not to obscure the example embodiments in unnecessary detail. In other instances, well-known processes, structures and techniques may be shown without unnecessary detail in order to avoid obscuring example embodiments.

In the following description, illustrative embodiments will be described with reference to acts and symbolic representations of operations (e.g., in the form of flow charts, flow diagrams, data flow diagrams, structure diagrams, block diagrams, etc.) that may be implemented as program modules or functional processes include routines, programs, objects, components, data structures, etc., that perform particular tasks or implement particular abstract data types and may be implemented using existing hardware at existing network elements (e.g., base stations, base station controllers, NodeBs, eNodeBs, etc.). Such existing hardware may include one or more Central Processing Units (CPUs), digital signal processors (DSPs), application-specific-integrated-circuits, field programmable gate arrays (FPGAs) computers or the like.

Although a flow chart may describe the operations as a sequential process, many of the operations may be performed in parallel, concurrently or simultaneously. In addition, the order of the operations may be rearranged. A process may be terminated when its operations are completed, but may also have additional steps not included in the figure. A process may correspond to a method, function, procedure, subroutine, subprogram, etc. When a process corresponds to a function, its termination may correspond to a return of the function to the calling function or the main function.

As disclosed herein, the term “storage medium” or “computer readable storage medium” may represent one or more devices for storing data, including read only memory (ROM), random access memory (RAM), magnetic RAM, core memory, magnetic disk storage mediums, optical storage mediums, flash memory devices and/or other tangible machine readable mediums for storing information. The term “computer-readable medium” may include, but is not limited to, portable or fixed storage devices, optical storage devices, and various other mediums capable of storing, containing or carrying instruction(s) and/or data.

Furthermore, example embodiments may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium such as a computer readable storage medium. When implemented in software, a processor or processors will perform the necessary tasks.

A code segment may represent a procedure, function, subprogram, program, routine, subroutine, module, software package, class, or any combination of instructions, data structures or program statements. A code segment may be coupled to another code segment or a hardware circuit by passing and/or receiving information, data, arguments, parameters or memory contents. Information, arguments, parameters, data, etc. may be passed, forwarded, or transmitted via any suitable means including memory sharing, message passing, token passing, network transmission, etc.

As used herein, the term “base station” may be considered synonymous to, and may hereafter be occasionally referred to, as an evolved Node B, eNodeB, Node B, base transceiver station (BTS), etc., and describes a transceiver in communication with and providing wireless resources to mobiles in a wireless communication network spanning multiple technology generations. As discussed herein, base stations may have all functionally associated with conventional, well-known base stations in addition to the capability and functionality discussed herein.

It is noted that the specific name for a base station in WCDMA is Node B (NB) and in LTE is enhanced Node B (eNB). The general name base station (BS) is used to include all applicable wireless technologies. Also in this disclosure, eMBMS is discussed for example purposes and used to represent other broadcast modes and/or technologies. It should be understood, however, that the techniques, methods and architectures discussed herein are applicable to various other broadcast modes and/or technologies, including but not limited to those discussed in this disclosure.

The term “user equipment,” as discussed herein, may be considered synonymous to, and may hereafter be occasionally referred to, as a client, mobile unit, mobile station, mobile user, mobile, subscriber, user, end user, remote station, access terminal, receiver, etc., and describes a remote user of wireless resources in a wireless communication network.

Collectively, user equipments and base stations may be referred to herein as “transceivers” or “radio frequency equipments.”

According to one or more example embodiments, a base station is located centrally across and above a distributed antenna system (DAS) (or similar) network.

More specifically, according to at least some example embodiments, the radio and antenna subsystem of a conventional base station is replaced with a DAS head end unit of a DAS network that replicates the input RF signal from the base station and routes the same signal to a plurality of DAS RF heads for radiation to end users.

A DAS network subdivides and distributes radio transmitter/receiver functionality of a base station among a number of smaller, lower-power antenna nodes (referred to herein as DAS RF heads or nodes). The DAS RF heads may include an antenna or antenna array, and may be deployed so as to provide coverage within underserved structures (e.g., in buildings) or over terrain where deployment of traditional cell towers is impractical or not permitted.

In the reverse direction, signals received at the DAS RF heads are combined for relay back to the base station. The base station down-converts the received RF signals into baseband signals for transmission into the network (not shown).

According to at least some example embodiments, the interface between the base station and the DAS network (or head end unit) may be the same or substantially the same as that between the RF modulation subsystem and the radio/antenna subsystem of a conventional base station. As such, multiple base stations from multiple service providers may be connected to single DAS head end unit, thus allowing the base stations to share a common access infrastructure.

DAS networks such as that discussed herein may be configured as RF-to-optical-to-RF systems. In this case, the DAS head end unit converts RF signals (e.g., eMBMS signals) from the base station to optical signals that are transported via fiber optic cable to DAS RF heads where the optical signal is converted back to a RF signal for transmission via the remote antenna. In another example, used by 3GPP Long Term Evolution (LTE) and WiMax operators, a DAS network may be configured as an optical driver-to-fiber-to-RF system. In this scenario, optical output head-end equipment drives light along the fiber to the DAS RF heads where the signal is converted into an RF signal for transmission to end users.

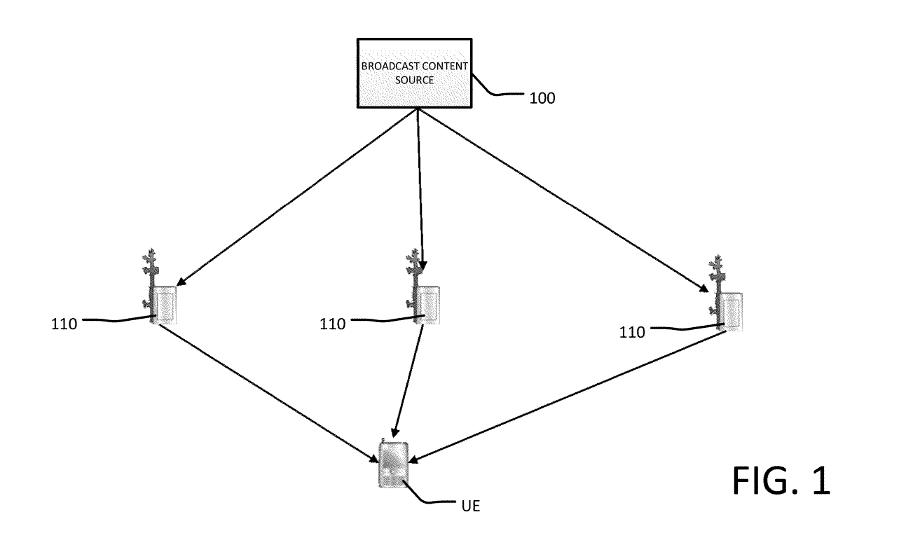

According to at least some example embodiments, rather than being radiated over the air from the base station itself as in the conventional architecture shown in FIG. 1, eMBMS signals from a base station are broadcast to receivers using a DAS network. More specifically, the base station sends the eMBMS signals to a DAS head-end, which replicates and sends or applies the same eMBMS signals to DAS radio-frequency (RF) heads or nodes. The DAS RF heads radiate/broadcast the eMBMS signals to end users in the serving area or sector.

End users in the serving area or sector receive the broadcast eMBMS signal in the same manner as in the conventional multi-base station architecture discussed above with regard to FIG. 1. Thus, receiver performance is not affected by this change in the delivery of eMBMS signals. Moreover, the relatively difficult synchronization discussed above with regard to FIG. 1 is not required.

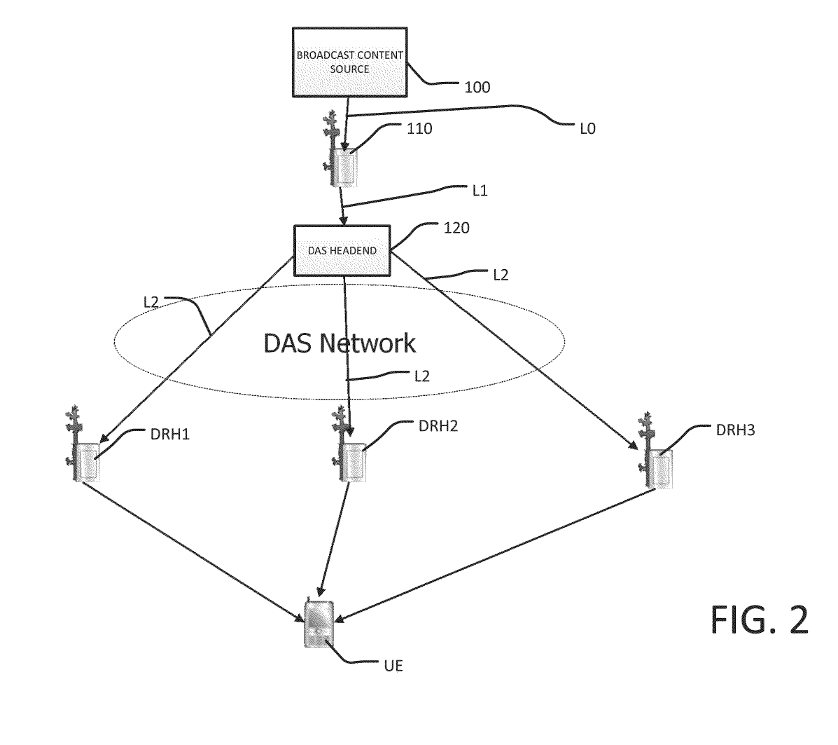

One or more example embodiments, and particularly the example embodiment shown in FIG. 2, will be discussed with regard to a single base station, single sector, a single DAS network and a single eMBMS signal. However, according to at least some example embodiments, an eMBMS signal may originate from one base station, but multiple sectors, where each sector signal is directed to one or more DAS RF Heads of the DAS network. Alternatively, all DAS RF heads may belong to a single sector. Moreover, the same methodology is applicable to multiple eMBMS signals or other broadcast signals.

FIG. 2 illustrates a MBMS architecture according to an example embodiment. In this example embodiment, eMBMS signals from a base station are broadcast to end users via a DAS network.

Referring to FIG. 2, a broadcast content server 100 is communicatively coupled to a base station 110 via a wired or wire-line connection L0. The broadcast content server 100 provides broadcast multimedia content (e.g., audio, video, data, etc.) to the base station 110 for broadcast transmission to end users such as the user equipment UE.

The base station 110 is communicatively coupled to a DAS network via a high-power (e.g., about 20 W) wired digital link L1. The high-power wired digital link L1 may be, for example, optical fiber, co-axial cable, etc.

The DAS network includes a DAS head end unit 120 and a plurality of DAS radio-frequency (RF) heads DRH1, DRH2, and DRH3. In the example embodiment shown in FIG. 2, the base station 110 is communicatively coupled to the DAS head end unit 120 via the high-power wired digital link L1.

Within the DAS network, the DAS head end unit 120 is communicatively coupled to the DAS RF heads DRH1, DRH2, and DRH3 via wired connections L2 (e.g., a high-power wired digital links, such as optical fibers, co-axial cables, etc.). Although only 3 DAS RF heads are shown in FIG. 2, example embodiments should not be limited to this example. Rather, the DAS network may include any number of DAS RF heads.

Still referring to FIG. 2, in example operation the base station 110 converts an input baseband signal (including, e.g., multimedia content) from the broadcast content server 100 into a passband signal on RF carriers (a RF signal or eMBMS signal). The base station 110 then outputs the eMBMS signal to the DAS head end 120 via the high-power digital link L1.

The DAS head end unit 120 replicates the input eMBMS signal from the base station 110 (e.g., to generate a plurality of copies of the eMBMS signal), and routes/transmits/applies the same eMBMS signal to each of the DAS RF heads DRH1, DRH2 and DRH3 via the digital link L2. Each DAS RF head DRH1, DRH2 and DRH3 then broadcasts the received eMBMS signal to end users (e.g., user equipment UE) within the serving sector or area over an RF link.

In the example embodiment shown in FIG. 2, each of the DAS RF heads DRH1, DRH2 and DRH3 broadcasts the same eMBMS signal. Thus, the user equipment UE in the single sector shown in FIG. 2 receives the same eMBMS signal from multiple DAS RF heads DRH1, DRH2 and DRH3 within the single sector. In other words, the user equipment UE receives a same broadcast eMBMS signal from a single base station via multiple DAS RF heads, and consequently, multiple transmission paths within a single sector of the network.

Example embodiments provide benefits over the conventional architecture shown in FIG. 1. The architecture shown in FIG. 2 does not suffer from inter-base station inter-modem or any inter-base station modem-to-antenna synchronization issue, such as timing differences. This considerably simplifies the network wide synchronization design.

Additionally, the eMBMS capacity (i.e., the number of users the eMBMS architecture is able to serve at any given time) is scalable without limitation. In other words, the eMBMS architecture may serve an infinite number of users within its serving area so far as the end user receives the broadcast transmission with adequate signal-to-interference-plus-noise-ratio.

The example embodiments discussed herein do not prevent delivering eMBMS via multiple base stations or broadcast units as in digital video broadcast (DVB) networks.

Additionally, according to at least some example embodiments the SFN gain is preserved as long as the DAS RF heads are in arranged in the same locations as base stations in the conventional architecture shown in FIG. 1, and transmit using the same power. In one example, an LTE system may apply such a technique, wherein the base station 110 in FIG. 2 is a LTE eNBs. In this case, any known DAS-like system may be employed (e.g., DAS-like systems existing in arenas, airports, convention centers, office complex, hotels, etc.)

Example embodiments provides for a more efficient solution for synchronization both across the back haul and intra-base station, which is a technical challenge. Example embodiments may also lower costs since only one base station (e.g., eNB) is necessary for broadcast transmission of MBMS within one or more sectors.

The foregoing description of example embodiments has been provided for purposes of illustration and description. It is not intended to be exhaustive or to limit the disclosure. Individual elements or features of a particular example embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

We claim:

1. A method for broadcasting multimedia broadcast multicast services (MBMS) signals over a distributed antenna system, the method comprising:
broadcasting a MBMS signal from a plurality of distributed antenna system radio frequency nodes of the distributed antenna system within a sector of a wireless network, the MBMS signal broadcast from each of the plurality of distributed antenna system radio frequency nodes being the same.

2. The method of claim 1, further comprising:
replicating the MBMS signal; and
applying the same MBMS signal to each of the plurality of distributed antenna system radio frequency nodes.

3. The method of claim 1, further comprising:
generating the MBMS signal based on multimedia content received from a broadcast content source.

4. The method of claim 3, further comprising:
replicating the MBMS signal; and
applying the same MBMS signal to each of the plurality of distributed antenna system radio frequency nodes.

5. The method of claim 1, further comprising:
receiving, at the plurality of distributed antenna system radio frequency nodes, the MBMS signal from a single base station in the sector.

6. A method for receiving multimedia broadcast multicast services (MBMS) signals over a distributed antenna system, the method comprising:
receiving, at a radio-frequency equipment, a broadcast MBMS signal from a plurality of distributed antenna system radio frequency nodes of the distributed antenna system within a sector of a wireless network, the broadcast MBMS signal received from each of the distributed antenna system radio frequency nodes being the same.

7. The method of claim 6, wherein the broadcast MBMS signal is from a single base station in the sector.

8. A system for broadcasting multimedia broadcast multicast services (MBMS) signals, the system comprising:
a radio frequency equipment configured to generate a MBMS signal based on multimedia content from a broadcast content source; and
a distributed antenna system having a plurality of distributed antenna system radio frequency nodes configured to broadcast the MBMS signal within a sector of a wireless network, the MBMS signal broadcast from each of the plurality of distributed antenna system radio frequency nodes being the same.

9. The system of claim 8, wherein the distributed antenna system comprises:
a distributed antenna system head end unit configured to replicate the MBMS signal, and to apply the same MBMS signal to each of the plurality of distributed antenna system radio frequency nodes.
